(19) United States
(12) Patent Application Publication
(10) Pub. No.: US 2012/0153897 A1
(43) Pub. Date: Jun. 21, 2012

(54) E-Z cord

(76) Inventors: Joseph Wisnewski, Waldorf, MD (US); Mariella Day, Waldorf, MD (US)

(21) Appl. No.: 13/373,645

(22) Filed: Nov. 23, 2011

Related U.S. Application Data
(60) Provisional application No. 61/458,453, filed on Nov. 23, 2010.

(51) Int. Cl. H02J 7/02

(52) U.S. Cl. 320/111

(57) ABSTRACT

The invention provides a retractable cell phone charger cord comprising a product line of cell phone chargers, each featuring an internal, spring-loaded reel to take up the cord, designed for use with a standard, 110-volt household electrical outlet, or a 12-volt adapter for use in an automobile. The charger casing is fabricated of injection-molded thermoplastic material. The charging cord and phone-plug emerge from a slot or recess in the bottom of the charger unit. In order to release the mechanism and reel-in or retract the cord, the exterior of the charger unit is equipped with a simple, spring-loaded release button.

### CLAIM OF PRIORITY

This patent application claims priority under 35 USC 119 (e) (1) from U.S. Provisional Patent Application Serial Number 61/458,453 filed Nov. 23, 2010, of common inventorship herewith entitled, “E-Z Cord.”

### FIELD OF THE INVENTION

The present invention pertains to the field of cell phone charging cords, and more specifically to the field of retractable cell phone charging cords.

### BACKGROUND OF THE INVENTION

The prior art has put forth several designs for retractable cell phone charger cords. Among these are:

U.S. Pat. No. 5,923,147 to Nils Martensson describes a battery charger unit incorporated in a power cord reel housing.

U.S. Pat. No. 6,059,081 to Gregory S. Patterson et al describes power accessories for a radiotelephone having a retractable power cord.

U.S. Pat. No. 6,806,682 to Leroy Hsiao describes a charging device with a retractable charging plug.

None of these prior art references describe the present invention.

### SUMMARY OF THE INVENTION

It is an object of the present invention to provide an improved cord for a cell phone charger, wherein the cord is retractable, and further comprises an integral 12 volt adapter.

### BRIEF DESCRIPTION OF THE DRAWINGS

FIG. 1 shows side and rear perspective view of the device of the present invention.

FIG. 2 shows a rear view of the device of the present invention with the plug slightly extended.

FIG. 3 shows a rear view of the device of the present invention with the 12 volt adapter in the extended position.

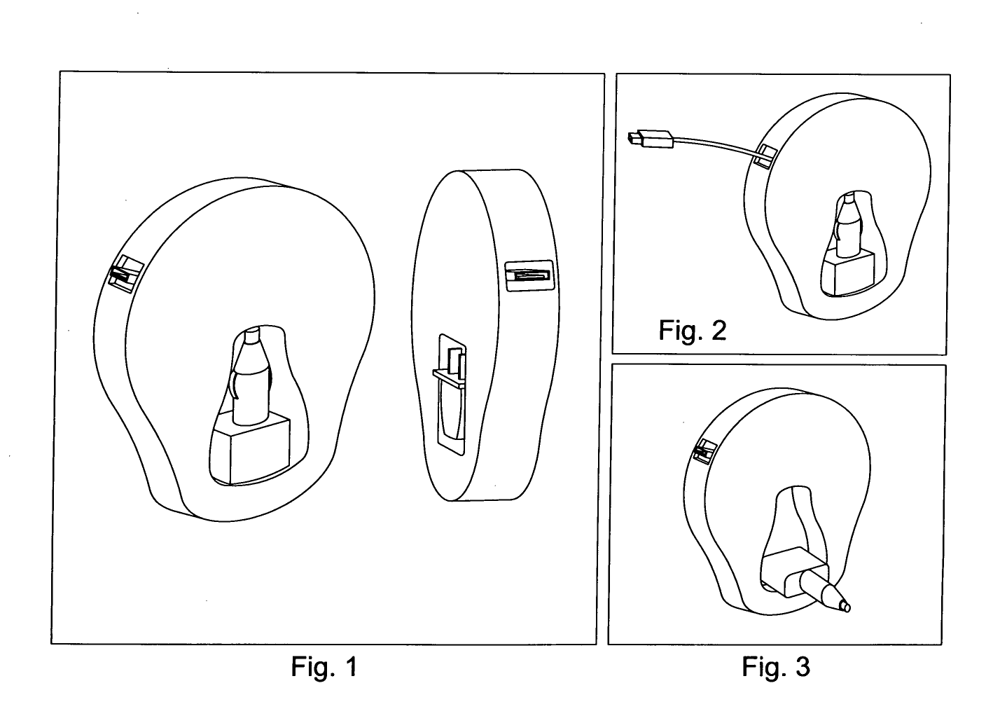

### DETAILED DESCRIPTION OF THE INVENTION

Most inventions fill a relatively small need or perform a specialized, limited function, but if that need is shared by a sufficient number of consumers, the invention may have a great potential for success. Consider, for example, that nearly all of us today are heavily dependent upon our cell phones. Now a cell phone is useful only so long as its battery holds a sufficient charge; and each phone requires a charger. The charging units for household use consist of a power plug, which feeds household current through a power rectifier, a device that converts the household outlet's alternating current into direct current for charging the phone's batteries into a cord that terminates in a plug, specific to the make and model of the phone. But while cell phone chargers are essential accessories, they're also an inconvenience. Between uses, the cord must be coiled up and bound, or risk getting the cord tangled, knotted, or mixed up with other cords. The present invention presents cell phone users with a simple, satisfying, and superior alternative to standard phone chargers.

Recognizing the potential to create a better cell phone charger, the present invention, referred to as the E-Z Cord, comprises a retractable cell phone charger cord. Simply stated, the E-Z Cord consists of a product line of cell phone chargers, each featuring an internal, spring-loaded reel to take up the cord, designed for use with a standard, 110-volt household electrical outlet, or a 12-volt adapter for use in an automobile. The E-Z Cord can be produced by the Radio and Television Broadcasting Equipment industry (Standard Industrial Code 3663, the same industry which produces the cell phones themselves). The E-Z cord can be marketed directly to the cell phone companies, and incorporated into the manufacture of new phones and chargers; or produced as add-on, aftermarket accessory for existing cell phones, in which case the units can be produced to match the plug-configuration and specific electrical requirements of the various makes and models of cell phones currently on the market. In both variations, the general concept and design is the same. The novel feature of the E-Z cord is that it is provides a retractable cell phone charger cord. Unlike conventional chargers, in which the charging cord hangs loosely from the unit, requiring the user to coil and bind it between uses, the E-Z Cord employs a ratchet-and-pawl type, internal, spring-loaded carrying reel to take up the excess cord, in a manner similar to that used in common articles ranging from dog-leashes to tape-measures. The charger unit itself measures approximately three inches in height by four and one half inches in width and one and a half inches in depth, wherein the device containing the power rectifier also includes a standard, two-prong electrical plug, as well as a single prong 12-volt adapter for use in the cigarette lighter outlet or 12-volt power outlet in an automobile. The charger casing is fabricated of injection-molded thermoplastic material. The charging cord and phone-plug emerge from a slot or recess in the bottom of the charger unit. Within the unit, a rotary, spring-loaded, ratchet-and-pawl reel functions to coil the excess cord. A ratchet-and-pawl mechanism is based on a wheel that has teeth cut out of it and a pawl that follows as the wheel turns. As the ratchet wheel turns, the spring-loaded pawl falls into the ‘dip’ between the teeth, preventing the wheel from backing up. Since the pawl locks the wheel, the ratchet wheel can only turn in one direction. What this means in terms of the E-Z Cord is that, when the user pulls the phone plug and cord out, the ratchet-and-pawl will function to hold the cord at any length the user desires. In order to release the mechanism and reel-in or retract the cord, the exterior of the charger unit is equipped with a simple, spring-loaded release button.

One further note regarding the technical aspects of the E-Z Cord regards its universality. Cell phone makers are currently working toward a universal, interchangeable charger plug that would work with all makes of cell phones. The universal plug should be available for all new phones by 2012. Clearly, a universal plug would be a big plus with regard to the E-Z Cord. The E-Z Cord presents consumers with a cleaner, neater, more compact cell phone charger, and eliminates the frustration and annoyance that attend the use of conventional chargers. With its spring-loaded, internal cord-reel, the E-Z Cord will function to release as much of the power cord as is needed for as long as is needed, then automatically takes up the cord and stores it neatly between uses. No more coiling and binding the cord; no more getting the cord tangled and twisted and knotted; no more trouble when packing the charger in briefcase, purse, or suitcase. The E-Z Cord presents itself as a compact, self-contained package, and keeps the charging cord coiled, safe, and out of the way when not in use.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A cell phone charger with retractable cord device, comprising:
a phone plug for insertion into the phone, a cord, an internal, spring-loaded reel to take up the cord, and a power plug for use with a standard, 110-volt household electrical outlet, or a 12-volt adapter for use in an automobile.

2. The device of claim 1 wherein the phone plug of the device matches the plug-configuration and specific electrical requirements of the various makes and models of cell phones currently on the market.

3. The device of claim 1 wherein the retractable cell phone charger cord employs a ratchet-and-pawl type, internal, spring-loaded carrying reel to take up the excess cord.

4. The device of claim 1 wherein the device measures approximately three inches in height by four and one half inches in width and one and a half inches in depth, wherein the device containing the power rectifier also includes a standard, two-prong electrical plug, as well as a single prong 12-volt adapter for use in the cigarette lighter outlet or 12-volt power outlet in an automobile.

5. The device of claim wherein the charger is housed in a casing fabricated of injection-molded thermoplastic material, and wherein the charging cord and phone-plug emerge from a slot or recess in the bottom of the device.

7. The device of claim 6, wherein a rotary, spring-loaded, ratchet-and-pawl reel functions to coil the excess cord, wherein the ratchet-and-pawl mechanism comprises a wheel that has teeth cut out of it and a pawl that follows as the wheel turns, wherein as the ratchet wheel turns, the spring-loaded pawl falls into the ‘dip’ between the teeth, preventing the wheel from backing up thereby locking the wheel with the pawl, the ratchet wheel can only turn in one direction. What this means in terms of the E-Z Cord is that, when the user pulls the phone plug and cord out, the ratchet-and-pawl will function to hold the cord at any length the user desires, further comprising a release mechanism to reel in or retract the cord.

8. The device of claim 7 wherein the release mechanism is a simple, spring-loaded release button mounted on the exterior of the charger unit.
